(19) United States
(12) Patent Application Publication
(10) Pub. No.: US 2006/0214565 A1
(43) Pub. Date: Sep. 28, 2006

(54) Top-emitting multi-photon OLED panel

(76) Inventors: Yongchun Luo, Yasu-shi (JP); Naomi Nagai, Yasu-shi (JP); Nobuhito Miura, Yasu-shi (JP); Naganori Tsutsui, Yasu-shi (JP); Shigeki Naka, Toyama-shi (JP); Hiroyuki Okada, Toyama-shi (JP); Hiroyoshi Onnagawa, Toyama-shi (JP)

Correspondence Address: MILDE & HOFFBERG, LLP, 10 BANK STREET, SUITE 460, WHITE PLAINS, NY, 10606, US

(21) Appl. No.: 11/378,795

(22) Filed: Mar. 16, 2006

(30) Foreign Application Priority Data
Mar. 25, 2005 (JP) 2005-088883

(51) Int. Cl. H05B 33/00

(52) U.S. Cl. 313/504; 313/506

(57) ABSTRACT

A top-emitting type multi-photon OLED panel comprises: an insulating substrate; a cathode formed on the insulating substrate; a plurality of organic layers laminated on the cathode; and a transparent anode formed on the top layer of the plurality of organic layers, wherein a charge generation layer is sandwiched between each organic layer.

### BACKGROUND OF THE INVENTION

1. Field of the Invention

The present invention relates to an organic electroluminescence panel (hereinafter referred to as OLED panel), in particular to a top-emitting type multi-photon OLED panel.

2. Description of Related Art

In an OLED panel, OLED elements are arranged on a substrate, such as a glass substrate to emit the OLED elements. The OLED panel is superior in electric power consumption, reaction speed, view field, and luminance. The OLED panel is expected as an epoch-making display and a flat-type lighting or the like.

Organic electroluminescent elements are configured by sandwiching an organic layer between an anode and a cathode. The organic layer may comprise a plurality of layers, such as an electron-injecting layer and/or a hole-injecting layer and an electron-transporting layer and/or a hole-transporting layer. Its emitting principle is similar to that of the emitting mechanism of light emitting diodes (LED). More specifically, a hole and an electron are fed into a light-emitting layer by the application of a direct current voltage between the anode and the cathode. The electronic state of organic molecules included in the light-emitting layer is shifted to the excited state by energy generated by a recombination of the hole and electron in the light-emitting layer. Energy is emitted as light when this quite unstable electronic state falls to a ground state so that the organic electroluminescent elements can emit light. Accordingly, organic electroluminescence is referred to also as organic light emitting device (OLED).

A method of taking out luminance of an OLED panel has two systems: bottom-emitting system and top-emitting system. As shown in FIG. 3, the bottom-emitting system takes out light from a glass substrate 16 side of an OLED panel 151 by laminating a transparent electrode 10, an organic layer 12, and a metal cathode 14 on the glass substrate 16. As shown in FIG. 4, the top-emitting system takes out light from a top surface electrode layer side 10 of an OLED panel 101 by laminating a metal electrode 14, an organic layer 12, and a transparent electrode 10.

While a single organic layer, such as the above-mentioned organic layer is sandwiched between an anode and a cathode in a conventional OLED panel, a multi-photon OLED panel for increasing light-emitting luminance of an OLED panel by the lamination of a plurality of organic layers has been developed. As shown in FIG. 5, a multi-photon OLED panel is formed by laminating a plurality of organic layers 12 between an Indium Tin Oxide (ITO) transparent electrode 10 formed on a glass substrate and a cathode 14 made of Al and sandwiching a charge generation layer (hereinafter referred to as CGL) 55 between each organic layer. The CGL layer 55 is formed by sputtering ITO on the organic layer or depositing a V₂O₅ layer.

However, there was a problem that a special chamber for deposition was needed, which resulted in an additional cost because the deposition of V₂O₅ layers had low reproducibility and needed to be performed at high temperatures. Further, there was another problem that the organic layers 12 were damaged by particles generated by sputtering when ITO was sputtered on the organic layers 12 as CGL layers 55.

Moreover, the above-mentioned multi-photon OLED panel 51 takes out light from the transparent electrode 10 side, such as ITO and the glass substrate 16 side because of being a bottom-emitting system. Accordingly, the luminous efficiency of light emitted from the organic layers 12 is deteriorated when transmitting the glass substrate 16 due to reflection and light attenuation.

Thus, it is an object of the present invention to provide a top-emitting type multi-photon OLED panel having high luminous efficiency at low production costs.

(Non-Patent Cited Document 1)

SID 03 DIGEST (Page 979 to 981)

(Non-Patent Cited Document 2)

Academic Lecture of The 64^{th} Applied Physics Society Lecture Draft (Page 1,178)

### SUMMARY OF THE INVENTION

A top-emitting type multi-photon OLED panel according to the present invention is so formed that a cathode is formed on an insulating substrate and a plurality of organic layers and CGL layers are alternately laminated on the cathode. More particularly, the top-emitting type multi-photon OLED panel comprises: an insulating substrate; a cathode formed on the insulating substrate; a plurality of organic layers laminated on the cathode; and a transparent anode formed on the top layer of the plurality of organic layers, wherein a CGL layer is sandwiched between each organic layer.

### BRIEF DESCRIPTION OF THE DRAWING

FIG. 1 is a cross-sectional view showing one embodiment of a top-emitting type multi-photon OLED panel according to the present invention.

FIGS. 2(a) and 2(b) are respectively a cross-sectional view of a top-emitting type multi-photon OLED panel according to the present invention.

FIG. 3 is a cross-sectional view of a conventional bottom-emitting OLED panel.

FIG. 4 is a cross-sectional view of a conventional top-emitting OLED panel.

FIG. 5 is a cross-sectional view of a conventional bottom-emitting type multi-photon OLED panel.

### DESCRIPTION OF THE PREFERRED EMBODIMENTS

Embodiments of the top-emitting type multi-photon OLED panel of the present invention will be now described with reference to the accompanying drawings. The same reference characters are used in common elements.

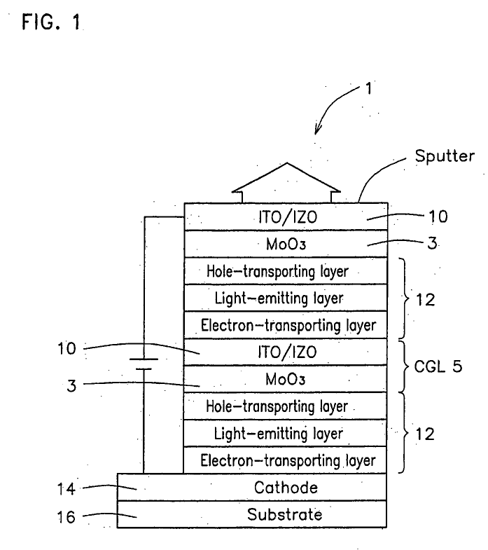

As shown in FIG. 1, in one embodiment of the present invention, an OLED panel 1 is a top-emitting type multi-photon OLED panel which comprises: an insulating substrate 16; a cathode 14 formed on the insulating substrate 16; a plurality of organic layers 12 laminated on the cathode 14; a transparent anode 10 formed on the top layer of the plurality of organic layers 12, wherein a CGL layer 5 is sandwiched between each organic layer 12.

First, the transparent anode 10 is formed by depositing a MoO₃ layer 3 on the top layer of the organic layers 12 and sputtering an ITO layer or an IZO (Indium Zinc Oxide) layer on the MoO₃ layer 3 (See Non-patent Cited Document 2). The MoO₃ layer 3 was deposited on the top layer of the organic layers 12 to protect the organic layers 12 from particles caused by sputtering when the ITO layer or the IZO layer is formed by sputtering. Unlike the deposition of the above-mentioned V₂O₅ layer, the deposition of the MoO₃ layer 3 has high reproducibility and needs no special chamber because there is no need to perform the deposition at high temperatures, which results in costs lower than that of the V₂O₅ layer.

The cathode 14 is made from a metal, such as Cr, Ti, Ta, Ni, Ag, and Al, but the kind of metal is not particularly limited. Alternatively, the cathode 14 may be made from a transparent electrode, such as ITO and IZO. Although an insulator, such as glass is generally used for the insulating substrate 16, a non-transparent metal substrate may be used in which an insulating layer is sandwiched between the cathode 14 and the insulating substrate 16 to prevent light from being radiated from the substrate 16 side when the cathode 14 is made from a transparent electrode, such as ITO.

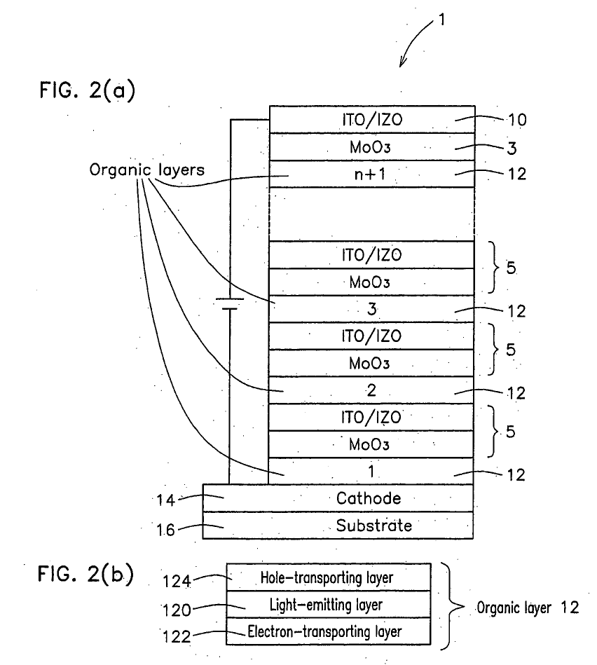

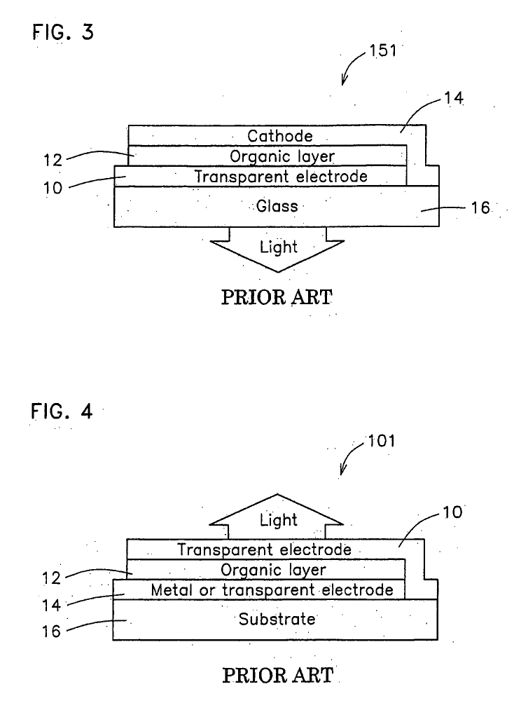

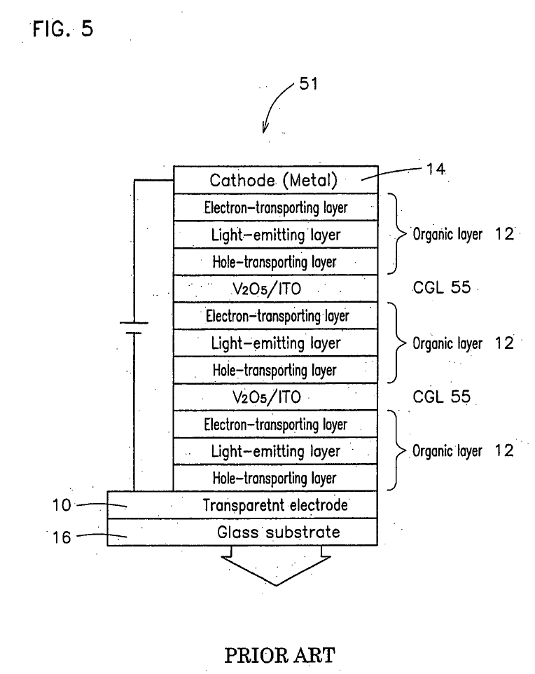

As shown in FIG. 2(b), the organic layer 12 may include a light-emitting layer 120. The light-emitting layer 120 may be sandwiched between an electron-transporting layer 122 on the cathode side and a hole-transporting layer 124 on the anode side. Alternatively, the organic layer 12 may comprise an electron-injecting layer on the cathode side of the electron-transporting layer 122 and a hole-injecting layer on the anode side of the hole-transporting layer 124.

As mentioned above, the OLED panel 1 for emitting light upward outside from the insulating substrate 16 toward the transparent anode 10 in the embodiment of the present invention is a top-emitting OLED panel. The OLED panel 1 is a multi-photon type, in which light emitted by the plurality of organic layers 12 is strengthened under certain conditions to be emitted from the transparent anode 10. Unlike the above-mentioned bottom-emitting OLED panel 51, the OLED panel 1 according to this embodiment can obtain high luminous efficiency because light emitted from the transparent anode 10 is not needed to transmit the glass substrate.

Further, in the OLED panel 1 according to this embodiment, the CGL layer 5 may be formed of the MoO₃ layer 3 deposited on each organic layer 12 and the ITO layer or the IZO layer of the transparent anode sputtered on the MoO₃ layer 3. The organic layers 12 can be protected from particles caused by sputtering when the ITO layer 10 or the IZO layer 10 is formed by sputtering because the MoO₃ layer 3 is deposited on each organic layer 12.

Alternatively, like a conventional method, the CGL layer 5 may be formed by depositing the V₂O₅ layer on each organic layer 12. In this case, the CGL layer 5 is formed only by the deposition of the V₂O₅ layer, so that the sputtering is not performed on the V₂O₅ layer, which leads to no need to laminate a protective layer, such as the MoO₃ layer 3 on each organic layer 12. In the case of forming the CGL layer 5 by the V₂O₅ layer, high luminous efficiency can be obtained without the necessity of light emitted from the transparent anode 10 transmitting the glass substrate as well because the OLED panel 1 is a top-emitting system.

As mentioned above, the deposition of the MoO₃ layer 3 has reproducibility higher than the V₂O₅ layer and needs no special chamber, which results in costs lower than that of the V₂O₅ layer.

In the top-emitting type multi-photon OLED panel 1 according to the present invention, the cathode 14 may be formed on the insulating substrate 16, and a plurality of organic layers 12 and CGL layers 5 may be alternately laminated on the cathode 14. More specifically, the top-emitting type multi-photon OLED panel 1 can be produced by forming a film with a general sputtering apparatus or a deposition apparatus using the steps below.

(1) Preparing the insulating substrate 16. (2) depositing the cathode 14 on the insulating substrate 16. (3) depositing the organic layer 12 on the cathode 14. (4) laminating the CGL layer 5 on the organic layer 12. More specifically, the MoO₃ layer 3 is deposited on the organic layer 12 and an ITO layer or an IZO layer is laminated on the MoO₃ layer 3 by sputtering. (5) alternately repeating at least n times (n≧1) the step of depositing the organic layer 12 on the CGL layer 5 and the step of laminating the CGL layer 5.

The top-emitting type multi-photon OLED panel 1 can be obtained from the above-mentioned steps, in which n+1 (n≧1) layers of the organic layers 12 are with the CGL layer 5 sandwiched between each organic layer 12, and an anode made from ITO or IZO with the MoO₃ layer 3 sandwiched on the top layer of the organic layers 12. The CGL layer 5 comprises the MoO₃ layer 3 deposited on a plurality of organic layers 12, and the ITO layer or the IZO layer sputtered on the MoO₃ layer 3 from the step (4), but the CGL layer 5 may be formed by depositing the V₂O₅ layer on each organic layer 12.

The top-emitting type multi-photon OLED panel of the present invention can obtain high luminance because light emitted by the plurality of organic layers is strengthened under certain conditions to be emitted from the top transparent anode. Further, unlike the bottom-emitting type OLED panel, the top-emitting type multi-photon OLED panel of the present invention can obtain high luminous efficiency because light emitted from the transparent anode 10 is not needed to transmit the glass substrate.

Moreover, in the top-emitting type multi-photon OLED panel of the present invention, the CGL layer comprises the MoO₃ layer deposited on each organic layer, and the ITO layer or the IZO layer sputtered on the MoO₃ layer. The organic layers 12 can be protected from particles caused by sputtering when the ITO layer or the IZO layer is formed by sputtering because the MoO₃ layer is deposited on the organic layer.

The deposition of the MoO₃ layer has reproducibility higher than the V₂O₅ layer, which enables mass production. In addition, the deposition needs no special chamber because of no need to perform the deposition of the MoO₃ layer at high temperatures, which results in costs lower than that of the V₂O₅ layer.

The embodiments of the present invention have been described so far, but the top-emitting type multi-photon OLED panel 1 of the present invention is not limited to the above-mentioned embodiments. The organic layers 12 are three layers in FIG. 1, but as shown in FIG. 2(a), the top-emitting type multi-photon OLED panel 1 may comprise an arbitrary number of organic layers 12.

In addition, the organic layers 12 may be arbitrary well-known organic layers and their components, material, thickness, and size or the like are not particularly limited. The anode 10 is not particularly limited to ITO or IZO and an arbitrary transparent electrode may be used. Each components, material, thickness, and size of the substrate 16 and the cathode 14 are not particularly limited.

There has thus been shown and described a novel top-emitting type multi-photon OLED panel which fulfills all the objects and advantages sought therefor. Many changes, modifications, variations, combinations, and other uses and applications of the subject invention will, however, become apparent to those skilled in the art after considering this specification and accompanying drawings which disclose the preferred embodiments thereof. All such changes, modifications, variations and other uses and applications which do not depart from the spirit and scope of the invention are deemed to be covered by the invention, Which is to be limited only by the claims which follow. This application claims priority from Japanese Patent Application No. 2005-088883, which is incorporated herein by reference.

What is claimed is:

1. A top-emitting type multi-photon OLED panel so formed that a cathode is formed on an insulating substrate and a plurality of organic layers and charge generation layers are alternately laminated on the cathode.

2. A top-emitting type multi-photon OLED panel comprising:
an insulating substrate;
a cathode formed on the insulating substrate;
a plurality of organic layers laminated on the cathode; and
a transparent anode formed on the top layer of the plurality of organic layers,
wherein a charge generation layer is sandwiched between each organic layer.

3. The OLED panel according to claim 1, wherein the charge generation layer comprises a MoO₃ layer deposited on each organic layer, and an Indium Tin Oxide layer or an Indium Zinc Oxide layer sputtered on the MoO₃ layer.

4. The OLED panel according to claim 1, wherein the charge generation layer is formed by depositing a V₂O₅ layer on each organic layer.

5. The OLED panel according to claim 2, wherein the transparent anode is formed of a MoO₃ layer deposited on the top layer of the organic layers and an Indium Tin Oxide layer or an Indium Zinc Oxide layer sputtered on the MoO₃ layer.

6. The OLED panel according to claim 1, wherein the organic layer comprises a light-emitting layer.

7. The OLED panel according to claim 1, wherein the organic layer comprises an electron-transporting layer and/or a hole-transporting layer.

8. The OLED panel according to claim 1, wherein the cathode is made of a metal either of Cr, Ti, Ta, Ni, Ag or Al.

9. The OLED panel according to claim 1, wherein the cathode is made of Indium Tin Oxide or Indium Zinc Oxide.

10. A method for manufacturing a top-emitting type multi-photon OLED panel comprising the steps of:
preparing an insulating substrate;
forming a cathode on the insulating substrate;
depositing an organic layer on the cathode;
laminating a charge generation layer on the organic layer; and
alternately repeating at least once the step of depositing the organic layer on the charge generation layer and the step of laminating the charge generation layer.

11. The method according to claim 10, wherein the charge generation layer is formed by depositing a MoO₃ layer on a plurality of organic layers and sputtering an Indium Tin Oxide layer or an Indium Zinc Oxide layer on the MoO₃ layer.
